(19) United States
(12) Patent Application Publication
(10) Pub. No.: US 2004/0111638 A1
(43) Pub. Date: Jun. 10, 2004

(54) Rule-based network survivability framework

(76) Inventors: Satyendra Yadav, Portland, OR (US); Nilesh M. Bhide, Redmond, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/315,579

(22) Filed: Dec. 9, 2002

(51) Int. Cl. H04L 9/00

(52) U.S. Cl. 713/201

(57) ABSTRACT

The present disclosure relates to the survivability of a network system and, more particularly, to a multi-tiered network intrusion detection and response system.

### BACKGROUND

1. Field

The present disclosure relates to the survivability of a network system and, more particularly, to a multi-tiered network intrusion detection and response system.

2. Background Information

In the context of this application, the survivability of a network system is defined as its ability to provide essential services in the presence of attacks and/or failures. Survivability of a network system may include the ability to recover the majority or all services in a timely manner. A service may be, for example, access to a server, email, the functioning of business system application, or other networked applications. Survivability may relate to the ability of the system to continue to perform at a reasonable service level, even in an adverse condition, such as, for example an intrusion attack, denial of service attack, etc.

Typically, a network intrusion detection system (NIDS) may analyze network traffic to detect intrusions and brute force attacks, such as, a denial of service attack. A typical NIDS may generate an alert for every suspicious activity observed in the network. For any network connected to a large network, such as, for example, the Internet, a typical NIDS can potentially generate thousands of alerts in a very short time.

Often the NIDS is running on a host machine, which may or may not be protected by the NIDS. The NIDS may consume the resources of the host machine in order to perform intrusion detection. A typical NIDS often attempts to process all the network traffic observable by the NIDS. In case of network conditions, such as, for example, a denial of service attack, the NIDS may consu me a majority, if not all, of the resources of the host machine in responding to the attack. Typically, in the absence of any human guidance, the NIDS are often forced to treat each network event at the same priority level, e.g. processing every packet sent as part of a denial of service attack. Therefore, any other services running on the host machine may be severely affected. In addition, the adverse condition may not allow the NIDS to generate alerts, take a reactionary measure, reply to an external high priority command, or other action.

In some instances, a self-inflicted denial of service may result due to the NIDS generating too many alerts due to, possibly, a configuration error. Often the typical NIDS has no way of adapting to various levels of network traffic and system events in order to maintain the survivability of the network and, possibly, a host machine.

### BRIEF DESCRIPTION OF THE DRAWINGS

Subject matter is particularly pointed out and distinctly claimed in the concluding portions of the specification. The claimed subject matter, however, both as to organization and the method of operation, together with objects, features and advantages thereof, may be best understood by a reference to the following detailed description when read with the accompanying drawings in which:

FIG. 1 is a network diagram illustrating an embodiment of a system and an apparatus in accordance with the disclosed matter; and

FIG. 2 is a flowchart illustrating a technique in accordance with the disclosed matter.

### DETAILED DESCRIPTION

In the following detailed description, numerous details are set forth in order to provide a thorough understanding of the present disclosed subject matter. However, it will be understood by those skilled in the art that the disclosed subject matter may be practiced without these specific details. In other instances, well-known methods, procedures, components, and circuits have not been described in detail so as to not obscure the disclosed subject matter.

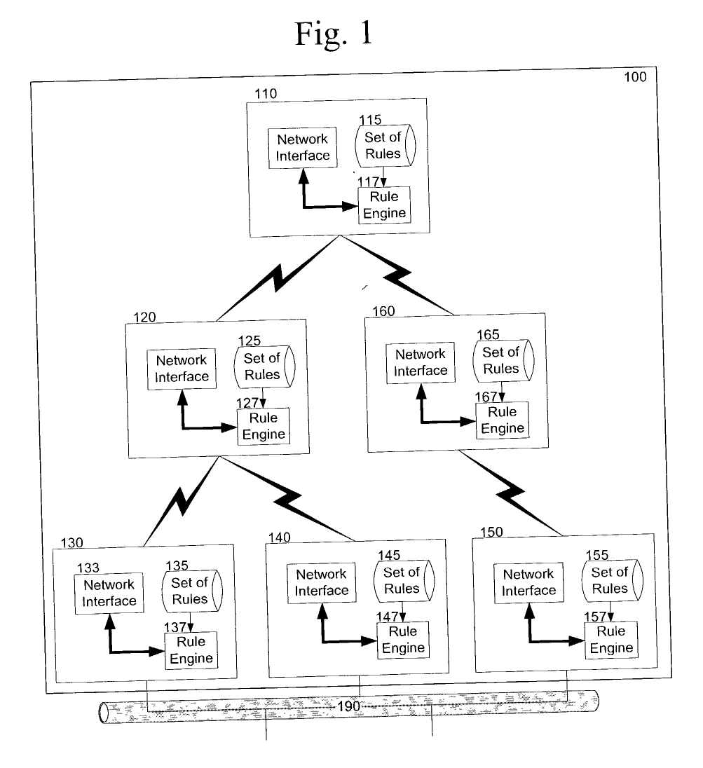

FIG. 1 is a network diagram illustrating an embodiment of a system and an apparatus in accordance with the disclosed matter. System 100 may include a multi-tiered network intrusion detection system (NIDS). In one embodiment, the NIDS may include network sensor devices (NSD) 130, 140 & 150, network operating centers (NOC) 120 & 160, and security operation center (SOC) 110. In this embodiment, NSDs 130, 140 & 150 may be deployed on multiple hosts to monitor and collect data about the behaviour of network 190. It is contemplated that these systems may be part of the network, or alternatively attached to the network. It is further contemplated that these systems may monitor a single network or the NIDS may be spread over multiple networks. This data may then be used to alert NOCs 120 & 160 about various security related events taking place on or observed by the NSDs. The NOCs may analyze the alerts and report information to the SOC. In this embodiment, SOC 110 may use these reports to generate, update and deploy security policies or rules that can protect against any vulnerabilities associated with the adverse network conditions.

In one embodiment, NSD 130 may include rule engine 137 to provide a flexible rule-based control mechanism to handle detected events. Rule engine 137 may process set of rules 135 to determine what parts of the network to monitor, what adverse network conditions to response to, and what actions to perform when an adverse network conditions is or is not detected. For example, set of rules 135 may determine that NSD 130 monitor parts of the network, such as, the state of a computer, an amount of computer processor usage, an amount of storage space available to a computer, traffic on a network or the available bandwidth of a network, or other measureable or estimatable characterisitc. In another example, set of rules 135 may specify that NSD 130 respond to adverse conditions, such as, a network identify spoofing attack, a denial-of-service attack, a password-based attack, a data modification attack, a man-in-the-middle attack, a worm attack, a compromised key attack, an application-layer attack, or other attack. In yet another example, set of rules 135 may specify that NSD 130 perform actions, such as, logging information pertaining to the adverse network condition to a file, forwarding data to a second network sensor device, transmitting an instruction or rule to a second network sensor device, transmitting a request for data to second network sensor device, ignoring the adverse network condition, altering an internal state of the rules engine, or altering the set of rules utilized by the network sensor device. Of course, these are merely a few illustrative examples to which the disclosed subject matter is not limited. It is contemplated that set of rules 135 may be configured to provide for none, some or all of the above examples.

In one specific example of an embodiment, NSD 130 may detect a denial of service attack and, according to a rule stored in set of rules 135, report the adverse network condition to NOC 120. NOC 120 may include set of rules 125 and rule engine 127. Rule engine 127, utilizing set of rules 125, may determine the way to act upon the report received from NSD 130. It is contemplated that NOC 120 may determine to perform a variety of actions, such as, for example, any of the actions described above in reference to set of rules 135.

In one embodiment, NOC 120 may report the adverse network condition to SOC 110. It is contemplated that NOC 120 may generate a report substantially different from the report received by NSD 130, or, alternatively, NOC 120 may transmit an identical report or a report incorporating the first report. SOC 110 may receive the report from NOC 120. SOC 110 may include a set of rules 115 and rule engine 117. The rule engine, utilizing set of rules 115, may determine how to act upon the report received from NOC 120. It is contemplated that SOC 110 may determine to perform a variety of actions, such as, for example, any of the actions described above in reference to set of rules 135. However, in one embodiment, SOC 110 may create a new set of rules for NSD 130. SOC 110 may distribute, either directly or indirectly, the rules to NSD 130. NSD 130 may update set of rules 135 with the new set of rules received from SOC 110. These rules may dynamically alter the parts of the network monitored, adverse conditions monitored, and actions performed by NSD 130.

In a specific example, NSD 130 may detect an adverse network condition that severely limits the capabilities of a small portion of a network. NSD 130 may generate a large number of reports to NOC 120. The large number of reports may, in turn, impair the ability of NOC 120 to function. NOC 120 may report this impairment to SOC 110. As a result, SOC 110 may generate a new set of rules for NSD 130 that causes NSD 130 to reduce the frequency of reporting the adverse network condition. This is merely one illustrative example that shows how the various network intrusion detection (NID) devices may interoperate and the disclosed subject matter is not limited to any one specific embodiment.

It is contemplated that NOCs 120 & 160 may also function as SOCs or NSDs. Likewise, it is contemplated that SOC 110 may functions as a NOC or NSD. Of course, in some embodiments, a NSD may function as a NOC or SOC. It is also contemplated that the rules for the NOC and SOC may be updated by other NID devices. While, FIG. 1, illustrates a NIDS utilizing a tree topology, it is contemplated that a variety of topologies may be utilized and the disclosed subject matter is not limited to the topology illustrate din FIG. 1. It is contemplated that the system may be arranged in a hierarchal fashion. In this context, the NSDs may be considered to comprise the lowest tier of the hierarchy. Conversely, in this context, the SOC may be considered to comprise the highest tier of the hierarchy. In this context, a higher tier is a tier that is topologically closer to a SOC, while a lower tier is a tier that is topologically closer to a NSD.

It is further contemplated that NSDs 130, 140 & 150 may utilize identical, similar, or divergent set of rules 135, 145, & 155, respectively. Likewise, NOCs 120 & 160 may utilize identical, similar, or divergent set of rules 125 & 165, respectively. Further, it is contemplated that each rule engine 117, 127, 137, 147, 157, & 167 may be configured to process the respective set of rules in an identical, similar or divergent manner.

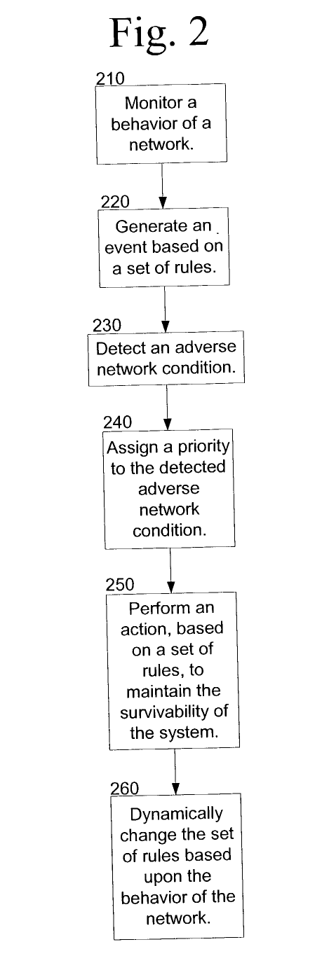

FIG. 1 is also a network diagram illustrating an embodiment of a possible apparatus in accordance with the disclosed matter. Network sensor devices (NSD) 130 may include a network interface 133, set of rules 135 and rule engine 137. These components may be configured to perform the actions illustrated by FIG. 2.

FIG. 2 is a flowchart illustrating an embodiment of a technique for operating an NSD in accordance with the disclosed matter. Block 210 illustrates that the NSD may monitor the behaviour of a network. It is contemplated that the NSD may be configured to monitor behaviors such as those described in detail in reference to FIG. 1, above; however, it is also contemplated that the disclosed subject matter is not limited to the illustrative examples above. It is further contemplated that network interface 133 of FIG. 1 may facilitate the monitoring of the network. It is contemplated that the network may include a host machine that may perform the technique illustrated by FIG. 2.

Block 220 illustrates that an event may be generated as a result of monitoring the behaviour of the network. It is contemplated that how the event is generated may be dictated by a set of rules. It is further contemplated that the event may be generated by a rule engine, such as, for example rule engine 137 of FIG. 1. It is also contemplated that the event may result from one or more observed behaviors of the network or, in addition, the state of a rule engine. It is further contemplated that, in one embodiment, block 220 of FIG. 2 need not be performed and every event may be considered an adverse network condition, as illustrated by block 230.

Block 230 illustrates that an adverse network condition may be detected. It is contemplated that, in one embodiment, only certain events may be classified as an adverse network condition. It is contemplated that the classification of events as adverse network conditions is dictated by a set of rules, such as, for example, set of rules 135 of FIG. 1. It is contemplated that the NSD may be configured to detect adverse network conditions such as those described in detail in reference to FIG. 1, above; however, the disclosed subject matter is not limited to the illustrative examples above.

Block 240 illustrates assigning a priority to the detected adverse network condition. It is contemplated that a set of rules may dictate the priority level assigned to each adverse network condition. It is also contemplated that the priority levels associated with particular events or adverse network conditions may change as a function of the state of the rule engine.

Block 250 illustrates that the NSD may perform an action, or actions, in order to attempt to maintain the survivability of the system. It is contemplated that the NSD may be configured to perform action(s) such as those described in detail in reference to FIG. 1, above; however, it is contemplated that the disclosed subject matter is not limited to the illustrative examples above. It is contemplated that the set of rules may dictate the action to be performed. It is also contemplated that the priority of the adverse condition may be contemplated when determining the proper action to perform. In one embodiment, if the priority of the adverse condition or event is sufficiently low, no action may be performed and the event may essentially be ignored. However, this is merely one specific example on an embodiment to which the disclosed subject matter is not limited.

Block 260 illustrates that the set of rules may be dynamically altered based, at least in part, upon the behavior of the network. For example, in one embodiment, a Network Operating Center (NOC), described above, may transmit a second set of rules to the NSD. This second set of rules may replace the first set of rules, in whole or part. In a second embodiment, the NSD may not receive a second set of rules from an outside source and merely detect that the first set of rules is insufficient to current network status, and alter the set of rules. It is contemplated that the NSD may utilize an adaptive system, such as, for example, a neural network, or an expert system, to alter the set of rules. It is contemplated that, in one embodiment, this adaptive system may utilize the first set of rules to generate any subsequent rule sets.

It is contemplated that the set of rules may include both a state and instruction component. The set of rules may dictate a first action, if the state component has a first value, and the set of rules may dictate a second action, if the state component has a second value. In one embodiment, the set of rules may define different states of readiness, or network performance, in order to predict and combat any adverse conditions which may affect the survivability of the network or NID system. It is contemplated that the rule set may define different states for other reasons. In one embodiment, the set of rules may be written in a programming or rule definition language, which may be statically compiled or dynamically interpreted. It is further contemplated that the set or rules and rule engine may be implemented in software, firmware, hardware or a mixture thereof.

The techniques described herein are not limited to any particular hardware or software configuration; they may find applicability in any local and/or distributed computing or processing environment. The techniques may be implemented in hardware, software or a combination of the two. The techniques may be implemented in programs executing on programmable machines such as mobile or stationary computers, personal digital assistants, and similar devices that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices.

Each program may be implemented in a high level procedural or object oriented programming language to communicate with a processing system. However, programs may be implemented in assembly or machine language, if desired. In any case, the language may be compiled or interpreted.

Each such program may be stored on a state preserving storage medium or device, e.g. compact read only memory (CD-ROM), digital versatile disk (DVD), hard disk, magnetic disk or similar medium or device, that is readable by a general or special purpose programmable machine for configuring and operating the machine when the storage medium or device is read by the computer to perform the procedures described herein. The system may also be considered to be implemented as a machine-readable or machine-accessible storage medium, configured with a program, where the storage medium so configured causes a machine to operate in a specific manner. Other embodiments are within the scope of the following claims.

While certain features of the disclosed subject matter have been illustrated and described herein, many modifications, substitutions, changes, and equivalents will now occur to those skilled in the art. It is, therefore, to be understood that the appended claims are intended to cover all such modifications and changes that fall within the true spirit of the disclosed subject matter.

What is claimed is:

1: A hierarchical system comprising:
at least one network sensor device (NSD) to monitor a behaviour of a network and perform a first action based at least in part upon a first set of rules;
at least one network operating center (NOC) to at least process events received from the at least one network sensor device; and
at least one system operating center (SOC) to at least
create a second set of rules and
distribute the second set of rules to selected ones of the at least one network sensor device or the at least one network operating center.

2: The hierarchal system of claim 1, wherein
the at least one network sensor device, the at least one network operating center, and the at least one system operating center are arranged in a tiered fashion;
the at least one network sensor device occupies the lowest tier of the hierarchical arrangement; and
the at least one system operating center occupies the highest tier of the hierarchical arrangement.

3: The system of claim 1, wherein the network sensor device includes:
a network interface to facilitate the monitoring of the behaviour of a network;
a storage medium to store a first set of rules; and
a rule engine to
detect a first adverse network condition utilizing, at least in part, the first set of rules; and
performing a first action based, at least in part, upon the first adverse network condition and the first set of rules.

4: The system of claim 1, wherein the first action performed by the rule engine includes at least one of the following:
logging information pertaining to the first adverse network condition to a file;
forwarding data to a second network sensor device;
transmitting an instruction or rule to a second network sensor device;
transmitting a request for data to second network sensor device;
ignoring the first adverse network condition;
altering an internal state of the rules engine; and
altering the first set of rules utilized by the network sensor device.

5: The system of claim 1, wherein the at least one network sensor device is capable of
receiving the second set of rules; and
updating the first set of rules utilizing the second set of rules.

6: The system of claim 1, wherein the network operating center includes a network sensor device.

7: The system of claim 1, wherein the network operating center is capable of
receiving events from the at least one network sensor device;
filtering the events utilizing a third set of rules; and
reporting at least one event to the system operating center.

8: The system of claim 7, wherein the network operating center is capable of
determining a second action to perform based on the third set of rules; and
transmitting a fourth set of rules to the network sensor device; and wherein the NSD is capable of, during operation,
receiving the fourth set of rules;
updating the first set of rules utilizing the fourth set of rules.

9: The system of claim 8, wherein the network sensor device is capable of updating the first set of rules utilizing at least one of the following:
modifying the first set of rules as instructed by the fourth set of rules;
replacing the first set of rules with the fourth set of rules; and
appending the fourth set of rules to the first set of rules.

10: The system of claim 8, wherein the network operating center is capable of
transmitting a fourth set of rules to a first network sensor device; and
transmitting a fifth set of rules to a second network sensor device.

11: The system of claim 8, wherein the system operating center is capable of
receiving a report from the at least one network operating center; and
transmitting the second set of rules in response to the received report.

12: The system of claim 11, wherein the system operating center is capable of
transmitting the second set of rules to at least one network sensor device.

13: The system of claim 11, wherein the sensor operating center includes a network sensor device.

14: The system of claim 13, wherein the sensor operating center is capable of dynamically creating the second set of rules utilizing a third set of rules.

15: An apparatus comprising:
a network interface to facilitate the monitoring of the behaviour of a network;
a memory to store a first set of rules; and
a rule engine to
detect a first adverse network condition utilizing, at least in part, the first set of rules; and
perform a first action based, at least in part, upon the first adverse network condition and the first set of rules.

16: The apparatus of claim 15, wherein the first action performed by the rule engine includes at least one of the following:
logging information pertaining to the first adverse network condition to a file;
forwarding data to a second network sensor device;
transmitting an instruction or rule to a second network sensor device;
transmitting a request for data to second network sensor device;
ignoring the first adverse network condition;
altering an internal state of the rules engine; and
altering the first set of rules utilized by the network sensor device.

17: The apparatus of claim 15, wherein the rule engine is capable of
receiving a second set of rules; and
updating the first set of rules utilizing the second set of rules.

18: The apparatus of claim 17, wherein the rule engine is capable of
receiving events from at least one network sensor device;
filtering the events utilizing the first set of rules; and
reporting at least one event to a system operating center.

19: The apparatus of claim 17, wherein the rule engine is capable of dynamically creating a third set of rules utilizing the first set of rules.

20: The apparatus of claim 19, wherein the rule engine is capable of monitoring a behaviour of a network.

21: The apparatus of claim 20, wherein the rule engine is capable of monitoring at least one of the following:
the state of a computer;
an amount of computer processor usage;
an amount of storage space available to a computer;
traffic on a network; and
the available bandwidth of a network.

22: The apparatus of claim 21, wherein the set of rules includes rules for generating an event as a result of at least one of the following network attacks:
a network identify spoofing attack;
a denial-of-service attack;
a password-based attack;
a data modification attack;
a man-in-the-middle attack;
a worm attack;
a compromised key attack; and
an application-layer attack.

23: A method of utilizing a first network intrusion detection device (NIDD) that is part of a network intrusion detection system (NIDS) that is arranged in a hierarchal fashion comprising:
monitoring a behaviour of a network;
detecting a first adverse network condition utilizing, at least in part, a first set of rules;
performing a first action to facilitate attempting to maintain the survivability of the network; and
dynamically changing the first set of rules based, at least in part, upon the behaviour of the network.

24: The method of claim 23, wherein dynamically changing the first set of rules includes:
reporting an event to a second device that is part of the network intrusion detection system that is part of a higher tier;
receiving a second set of rules from the second device; and
altering the first set of rules utilizing, at least in part, the second set of rules.

25: The method of claim 23, further comprising:
generating a first event based, at least in part, upon the monitored behaviour and the first set of rules; and
wherein detecting a first adverse network condition includes:
considering the first event to be an adverse network condition based, at least in part, upon the first set of rules.

26: The method of claim 25, further comprising:
monitoring, at least in part, of at least one of the following:
the state of a computer;
an amount of computer processor usage;
an amount of storage space available to a computer;
traffic on a network; and
the available bandwidth of a network; and
generating a first event based at leats in part upon the monitoring.

27: The method of claim 25, wherein performing the first action includes:
assigning the first adverse network condition a priority based, at least in part upon, the first set of rules; and
further comprising:
selecting the first action to perform based, at least in part, upon the assigned priority.

28: The method of claim 25, wherein performing the first action includes ignoring the first adverse network condition if the first network condition is assigned a low priority.

29: The method of claim 25, wherein performing the first action includes performing at least one of the following actions:
logging the occurrence of the adverse network condition;
forwarding data to a second device that is part of the network intrusion detection system;
transmitting an instruction or rule to a second device that is part of the network intrusion detection system;
transmitting a request for data to a second device that is part of the network intrusion detection system;
altering an internal state machine of to a second device that is part of the network intrusion detection system; and
altering a rule utilized by to a second device that is part of the network intrusion detection system.

30: An article comprising:
a storage medium having a plurality of machine accessible instructions, wherein when the instructions are executed by a machine, the instructions provide for utilizing a first network intrusion detection device (NIDD) that is part of a network intrusion detection system (NIDS) that is arranged in a hierarchal fashion comprising:
monitoring a behaviour of a network;
detecting a first adverse network condition utilizing, at least in part, a first set of rules;
performing a first action to facilitate attempting to maintain the survivability of the network; and
dynamically changing the first set of rules based, at least in part, upon the behaviour of the network.

31: The article of claim 30, wherein the instructions providing for dynamically changing the first set of rules includes instructions for:
reporting an event to a second device that is part of the network intrusion detection system that is part of a higher tier;
receiving a second set of rules from the second device; and
altering the first set of rules utilizing, at least in part, the second set of rules.

32: The article of claim 30, wherein the instructions providing for performing a first action to facilitate attempting to maintain the survivability of the network includes instructions for:
logging the occurrence of the adverse network condition to a file; and
transmitting data to a second network intrusion detection device that is part of a higher tier.
